(19) United States
(12) Patent Application Publication
(10) Pub. No.: US 2025/0182326 A1
(43) Pub. Date: Jun. 5, 2025

(54) TECHNIQUES FOR POSE ESTIMATION AND TRACKING OF NOVEL OBJECTS

(71) Applicant: NVIDIA CORPORATION, Santa Clara, CA (US)

(72) Inventors: Bowen WEN, Bellevue, WA (US); Stanley BIRCHFIELD, Sammamish, WA (US); Wei YANG, Lake Forest Park, WA (US); Jan KAUTZ, Lexington, MA (US)

(21) Appl. No.: 18/740,276

(22) Filed: Jun. 11, 2024

Related U.S. Application Data
(60) Provisional application No. 63/606,360, filed on Dec. 5, 2023.

(51) Int. Cl. G06T 7/73

(52) U.S. Cl. CPC G06T 7/75; G06T 2207/10016; G06T 2207/20081; G06T 2207/20132

(57) ABSTRACT

One embodiment of a method for determining object poses includes receiving a first image of an object, sampling an initial pose of the object, performing one or more operations to update the initial pose to determine a first pose of the object based on the first image, a first rendered image of the object in the initial pose, and one or more transformer encoders.

### CROSS-REFERENCE TO RELATED APPLICATIONS

This application claims benefit of the United States Provisional Patent Application titled “TECHNIQUES FOR UNIFIED 6D POSE ESTIMATION AND TRACKING OF OBJECTS,” filed Dec. 5, 2023, and having Ser. No. 63/606,360. The subject matter of this related application is hereby incorporated herein by reference.

### BACKGROUND

### Field of the Various Embodiments

The various embodiments relate generally to computer science, artificial intelligence (AI), and computer vision and, more specifically, to techniques for pose estimation and tracking of novel objects.

### Description of the Related Art

In computer-based vision applications, object pose estimation refers to the task of determining the position and orientation of an object in three-dimensional (3D) space. For example, the pose of an object can be estimated in six degrees of freedom (6-DoF) by determining three position coordinates and three rotation coordinates of the object. Object pose estimation is used in a wide range of applications, such as robotic manipulation, augmented/mixed reality, and autonomous navigation.

One conventional approach for object pose estimation is to train a machine learning model using different images of a given object and labels for the poses of the given object in the different images. Once trained, the machine learning model can be used to predict the poses of the given object in new images.

One drawback of the above approach for object pose estimation is that, as a general matter, the trained machine learning model can correctly predict poses only for the same object or category of objects used to train the machine learning model. When the trained machine learning model is applied to estimate the poses of other objects or objects of other types, the trained machine learning model can predict incorrect poses that are not reflective of the actual poses of those objects within the relevant images.

As the foregoing illustrates, what is needed in the art are more effective techniques for object pose estimation.

### SUMMARY

One embodiment of the present disclosure sets forth a computer-implemented method for determining object poses. The method includes receiving a first image of an object. The method further includes sampling an initial pose of the object. In addition, the method includes performing one or more operations to update the initial pose to determine a first pose of the object based on the first image, a first rendered image of the object in the initial pose, and one or more transformer encoders.

One technical advantage of the disclosed techniques relative to the prior art is that, with the disclosed techniques, a trained machine learning model can be used to predict the poses of different objects, including other objects and objects of different types that were not included in images used to train the machine learning model. In addition, with the disclosed techniques, the trained machine learning model can be applied to predict the poses of objects in standalone images as well as in multiple frames of a video. The disclosed techniques also can be used to predict the poses of objects for which a computer-aided design (CAD) model is available as well as the poses of objects for which no CAD model is available. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be found by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computer system configured to implement one or more aspects of the various embodiments;

FIG. 2 is a block diagram of a parallel processing unit included in the parallel processing subsystem of FIG. 1, according to various embodiments;

FIG. 3 is a block diagram of a general processing cluster included in the parallel processing unit of FIG. 2, according to various embodiments;

FIG. 4 is a more detailed illustration of the pose estimation application of FIG. 1, according to various embodiments;

FIG. 5 is a more detailed illustration of the pose hypothesis module of FIG. 4, according to various embodiments;

FIG. 6 is a more detailed illustration of the pose refinement module of FIG. 5, according to various embodiments;

FIG. 7 is a more detailed illustration of the pose selection module of FIG. 5, according to various embodiments;

FIG. 8 is a flow diagram of method steps for estimating the pose of an object, according to various embodiments;

FIG. 9 is a flow diagram of method steps for computing intermediate pose estimates, according to various embodiments; and

FIG. 10 is a flow diagram of method steps for selecting an intermediate pose estimate, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for six degree of freedom (6-DoF) object pose estimation. In some embodiments, a pose estimation application receives one or more images of an object, such as images captured from different viewpoints and/or the frames of a video. The pose estimation application optionally generates an object model for rendering images of the object. The object model can be an object-centric neural field representation that includes a geometry model that can be queried to render geometry of the object and an appearance model that can be queried to render colors of the object. Using the object model or a received computer-aided design (CAD) model of the object, the pose estimation application computes intermediate pose estimates for the object within an image via a render and compare technique. The render and compare technique uses transformer encoders, among other things, to compute position and rotation updates that can be applied to an initial sampled pose estimate to obtain a refined pose. In addition, multiple initial pose estimates can be sampled, and the pose estimation application can select one of the refined poses computed for the multiple initial pose estimates using a hierarchical self-attention technique that ranks the refined poses.

The object pose estimation techniques of the present disclosure have many real-world applications. For example, the object pose estimation techniques can be used in robotic manipulation, augmented/mixed reality, and autonomous navigation, among other things.

The above examples are not in any way intended to be limiting. As persons skilled in the art will appreciate, as a general matter, the object pose estimation techniques described herein can be implemented in any application where object pose estimates are required or useful.

### System Overview

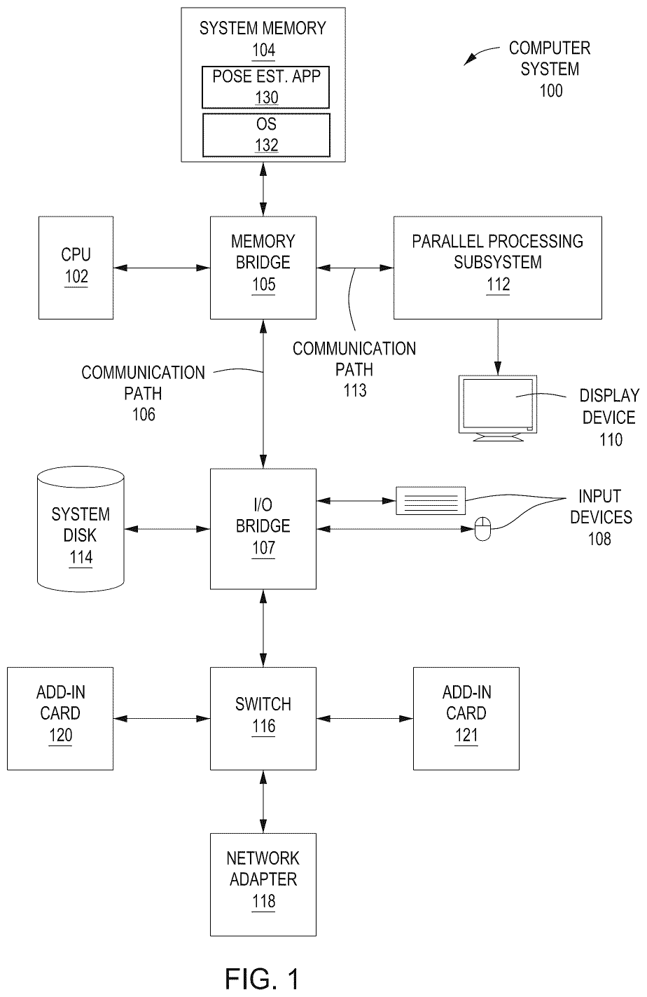

FIG. 1 is a block diagram illustrating a computer system 100 configured to implement one or more aspects of the present embodiments. As persons skilled in the art will appreciate, computer system 100 can be any type of technically feasible computer system, including, without limitation, a server machine, a server platform, a desktop machine, laptop machine, a hand-held/mobile device, or a wearable device. In some embodiments, computer system 100 is a server machine operating in a data center or a cloud computing environment that provides scalable computing resources as a service over a network.

In various embodiments, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as a keyboard or a mouse, and forward the input information to CPU 102 for processing via communication path 106 and memory bridge 105. In some embodiments, computer system 100 may be a server machine in a cloud computing environment. In such embodiments, computer system 100 may not have input devices 108. Instead, computer system 100 may receive equivalent input information by receiving commands in the form of messages transmitted over a network and received via network adapter 130. In one embodiment, switch 116 is configured to provide connections between I/O bridge 107 and other components of computer system 100, such as a network adapter 130 and various add-in cards 120 and 121.

In one embodiment, I/O bridge 107 is coupled to a system disk 114 that may be configured to store content and applications and data for use by CPU 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

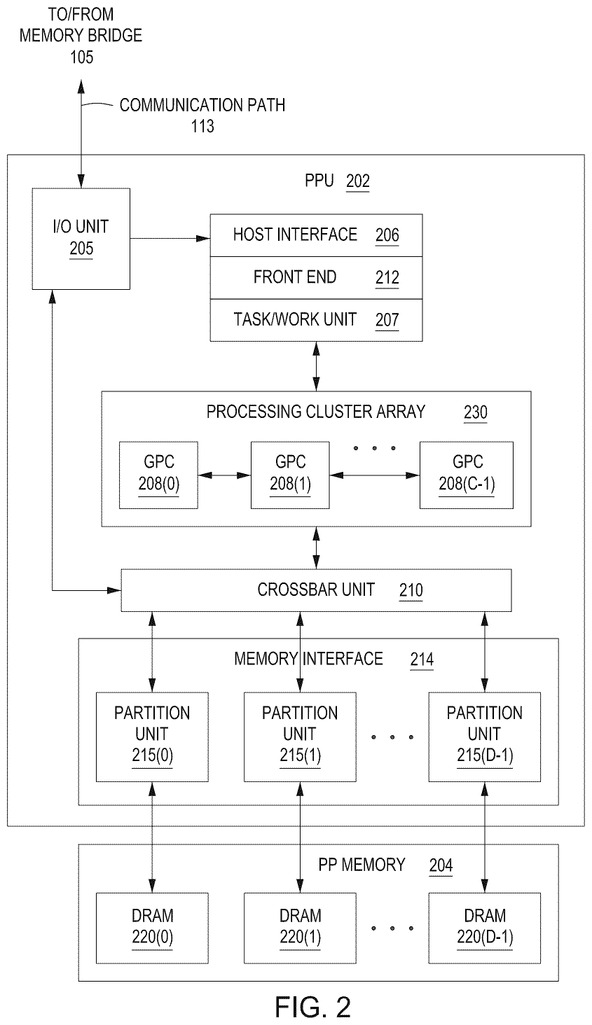

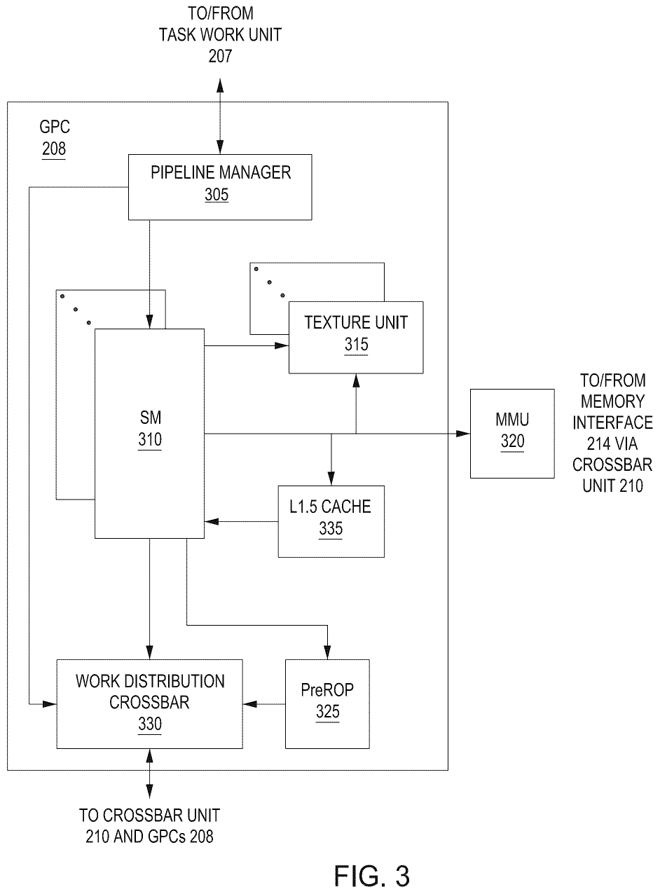

In some embodiments, parallel processing subsystem 112 comprises a graphics subsystem that delivers pixels to an optional display device 110 that may be any conventional cathode ray tube, liquid crystal display, light-emitting diode display, or the like. In such embodiments, parallel processing subsystem 112 incorporates circuitry optimized for graphics and video processing, including, for example, video output circuitry. As described in greater detail below in conjunction with FIGS. 2-3, such circuitry may be incorporated across one or more parallel processing units (PPUs), also referred to herein as parallel processors, included within parallel processing subsystem 112. In other embodiments, parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations.

Illustratively, system memory 104 stores a pose estimation application 130 and an operating system 132 on which pose estimation application 130 runs. Operating system 132 can be, e.g., Linux®, Microsoft Windows®, or macOS®. Pose estimation application 130 can be any technically feasible application that estimates the poses of objects according to techniques disclosed herein. For example, in some embodiments, pose estimation application 130 can be a robotic control application, an augmented/mixed reality application, or an autonomous navigation application that estimates the poses of objects in order to control a robot, render objects within an augmented or mixed reality scene, or control a vehicle, respectively. Although described herein primarily with respect to pose estimation application 130 as a reference example, techniques disclosed herein can also be implemented, either entirely or in part, in other software and/or hardware, such as in parallel processing subsystem 112.

In various embodiments, parallel processing subsystem 112 may be integrated with one or more of the other elements of FIG. 1 to form a single system. For example, parallel processing subsystem 112 may be integrated with CPU 102 and other connection circuitry on a single chip to form a system on chip (SoC).

In one embodiment, CPU 102 is the master processor of computer system 100, controlling and coordinating operations of other system components. In one embodiment, CPU 102 issues commands that control the operation of PPUs. In some embodiments, communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other embodiments, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 could be eliminated, and network adapter 130 and add-in cards 120, 121 would connect directly to I/O bridge 107. Lastly, in certain embodiments, one or more components shown in FIG. 1 may be implemented as virtualized resources in a virtual computing environment, such as a cloud computing environment. In particular, parallel processing subsystem 112 may be implemented as a virtualized parallel processing subsystem in some embodiments. For example, parallel processing subsystem 112 could be implemented as a virtual graphics processing unit (GPU) that renders graphics on a virtual machine (VM) executing on a server machine whose GPU and other physical resources are shared across multiple VMs.

FIG. 2 is a block diagram of a parallel processing unit (PPU) 202 included in parallel processing subsystem 112 of FIG. 1, according to various embodiments. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a GPU that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to an optional display device 110 for display. In some embodiments, PPU 202 also may be configured for general-purpose processing and compute operations. In some embodiments, computer system 100 may be a server machine in a cloud computing environment. In such embodiments, computer system 100 may not have a display device 110. Instead, computer system 100 may generate equivalent output information by transmitting commands in the form of messages over a network via network adapter 130.

In some embodiments, CPU 102 is the master processor of computer system 100, controlling and coordinating operations of other system components. In one embodiment, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a command queue, also referred to herein as a pushbuffer, to initiate processing of the stream of commands in the data structure. In one embodiment, PPU 202 reads command streams from the command queue and then executes commands asynchronously relative to the operation of CPU 102. In embodiments where multiple pushbuffers are generated, execution priorities may be specified for each pushbuffer by an application program via device driver to control scheduling of the different pushbuffers.

In one embodiment, PPU 202 includes an I/O (input/output) unit 205 that communicates with the rest of computer system 100 via communication path 113 and memory bridge 105. In one embodiment, I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. In one embodiment, host interface 206 reads each command queue and transmits the command stream stored in the command queue to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In one embodiment, front end 212 transmits processing tasks received from host interface 206 to a work distribution unit (not shown) within task/work unit 207. In one embodiment, the work distribution unit receives pointers to processing tasks that are encoded as task metadata (TMD) and stored in memory. The pointers to TMDs are included in a command stream that is stored as a command queue and received by front end unit 212 from host interface 206. Processing tasks that may be encoded as TMDs include indices associated with the data to be processed as well as state parameters and commands that define how the data is to be processed. For example, the state parameters and commands could define the program to be executed on the data. Also, for example, the TMD could specify the number and configuration of the set of CTAs. Generally, each TMD corresponds to one task. The task/work unit 207 receives tasks from front end 212 and ensures that GPCs 208 are configured to a valid state before the processing task specified by each one of the TMDs is initiated. A priority may be specified for each TMD that is used to schedule the execution of the processing task. Processing tasks also may be received from processing cluster array 230. Optionally, the TMD may include a parameter that controls whether the TMD is added to the head or the tail of a list of processing tasks (or to a list of pointers to the processing tasks), thereby providing another level of control over execution priority.

In one embodiment, PPU 202 implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

In one embodiment, memory interface 214 includes a set of D of partition units 215, where D≥1. Each partition unit 215 is coupled to one or more dynamic random access memories (DRAMs) 220 residing within PPM memory 204. In some embodiments, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

In one embodiment, a given GPC 208 may process data to be written to any of the DRAMs 220 within PP memory 204. In one embodiment, crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In some embodiments, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between GPCs 208 and partition units 215.

In one embodiment, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

In one embodiment, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, wearable devices, servers, workstations, game consoles, embedded systems, and the like.

FIG. 3 is a block diagram of a general processing cluster (GPC) 208 included in the parallel processing unit (PPU) 202 of FIG. 2, according to various embodiments. As shown, GPC 208 includes, without limitation, a pipeline manager 305, one or more texture units 315, a preROP unit 325, a work distribution crossbar 330, and an L1.5 cache 335.

In one embodiment, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

In one embodiment, operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In various embodiments, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, 5OR), bit-shifting, and computation of various algebraic functions (e.g., planar interpolation and trigonometric, exponential, and logarithmic functions, etc.). Advantageously, the same functional execution unit can be configured to perform different operations.

In one embodiment, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within SM 310, in which case some of the execution may be idle during cycles when that thread group is being processed. A thread group may also include more threads than the number of execution units within SM 310, in which case processing may occur over consecutive clock cycles. Since each SM 310 can support up to G thread groups concurrently, it follows that up to G*M thread groups can be executing in GPC 208 at any given time.

Additionally, in one embodiment, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within SM 310, and m is the number of thread groups simultaneously active within SM 310. In some embodiments, a single SM 310 may simultaneously support multiple CTAs, where such CTAs are at the granularity at which work is distributed to SMs 310.

In one embodiment, each SM 310 contains a level one (L1) cache or uses space in a corresponding L1 cache outside of SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, SMs 310 may beneficially share common instructions and data cached in L1.5 cache 335.

In one embodiment, each GPC 208 may have an associated memory management unit (MMU) 320 that is configured to map virtual addresses into physical addresses. In various embodiments, MMU 320 may reside either within GPC 208 or within memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In one embodiment, in graphics and compute applications, GPC 208 may be configured such that each SM 310 is coupled to a texture unit 315 for performing texture mapping operations, such as determining texture sample positions, reading texture data, and filtering texture data.

In one embodiment, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs.

### Pose Estimation and Tracking of Novel Objects

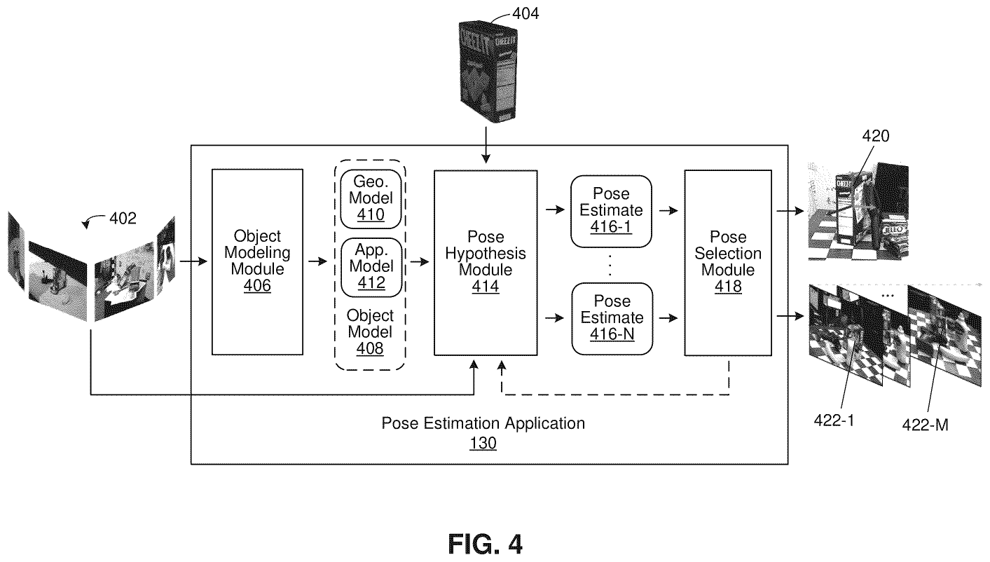

FIG. 4 illustrates in greater detail the pose estimation application 130 of FIG. 1, according to various embodiments. As shown, pose estimation application 130 includes, without limitation, an object modeling module 406, a pose hypothesis module 414, and a pose selection module 418. In operation, pose estimation application 130 receives as inputs one or more images 402 of an object and, optionally, a texture CAD model 404. For example, input image(s) 402 can include standalone images captured from different viewpoints, or multiple frames of a video. It is assumed herein that the relative poses between input image(s) 402 are known. Given such inputs, pose estimation application 130 estimates a pose 420 of the object in the case of an input image, or a sequence of poses 422-1 to 422-M (referred to herein collectively as poses 422 and individually as a pose 422) across the frames of an input video.

Object modeling module 406 generates, from input image(s) 402, an object model 408 that can be used to render images of the object in different poses. In some embodiments, object model 408 can include an object-centric neural field representation that is trained using input image(s) 402. Illustratively, object model 408 includes (1) a geometry model 410 that is a signed distance field (SDF) representation trained from input image(s) 402, and (2) an appearance model 412 that is trained using input image(s) 402 to learn a RGB (red, green, blue) rendering. Geometry model 410 can be queried to determine a geometry of the object, and appearance model 412 can be queried to determine a color appearance of the object. More formally, in some embodiments, object model 408 can be an object-centric neural field representation of an object by two functions. First, geometry model 410 can be a geometry function Ω: x→s that takes as input a 3D point x∈ [symbol] ³ and outputs a signed distance value s∈ [symbol] . Second, appearance model 412 can be an appearance function Φ: (f_{Ω(x)}, n, d)→c that takes the intermediate feature vector f_{Ω(x)} from the geometry function, a point normal n∈ [symbol] ³, and a view direction d∈ [symbol] ³, and outputs the color c∈ [symbol] ₊³. In practice, multi-resolution hash encoding can be applied to the 3D point x before forwarding x to the geometry function. Both the point normal n and the view direction d can be embedded by a fixed set of second-order spherical harmonic coefficients. The implicit object surface can then be obtained by taking the zero level set of the SDF: S={x∈ [symbol] ³|Ω(x)=0}. Compared to a neural radiance field (NeRF), the SDF representation Ω provides higher quality depth rendering while removing the need to manually select a density threshold.

For texture learning to train appearance model 412, volumetric rendering over truncated near-surface regions can be used in some embodiments:

$$c ( r ) = {\int }_{z ( r ) - λ}^{z ( r ) + 0.5 λ} w ( {x}_{i} ) Φ ( {f}_{Ω ( {x}_{i} )} , n ( {x}_{i} ) , d ( {x}_{i} ) ) dt , \qquad ( 1 )$$

$$w ( {x}_{i} ) = \frac{1}{1 + {e}^{- αΩ ( {x}_{i} )}} \frac{1}{1 + {e}^{αΩ ( {x}_{i} )}} , \qquad ( 2 )$$

where w(xᵢ) is a bell-shaped probability density function that depends on the signed distance Ω(xᵢ) from the point to the implicit object surface, and a adjusts the softness of the distribution. The probability peaks at the surface intersection. In equation (1), z(r) is the depth value of the ray from the depth image, and λ is the truncation distance. The contribution from empty space that is more than λ away from the surface can be ignored for more efficient training, and up to a 0.5λ penetrating distance can be integrated to model self-occlusion. During training, this quantity can be compared against reference RGB images for color supervision:

$${ℒ}_{c} = {‖ c ( r ) - \overline{c} ( r ) ‖}_{2} , \qquad ( 3 )$$

where c̅(r) denotes the ground-truth color at the pixel where the ray r passes through.

For geometry learning to train geometry model 410, the hybrid SDF model can be used by dividing the space into two regions to learn an SDF, leading to an empty space loss and a near surface loss. Eikonal regularization can also be applied to the near-surface SDF:

$${ℒ}_{e} = \frac{1}{\vert {𝒳}_{e} \vert} {\sum }_{x ∈ {𝒳}_{e}} \vert Ω ( x ) - λ \vert , \qquad ( 4 )$$

$${ℒ}_{s} = \frac{1}{\vert {𝒳}_{s} \vert} {\sum }_{x ∈ {𝒳}_{s}} {( Ω ( x ) + {d}_{x} - {d}_{D} )}^{2} , \qquad ( 5 )$$

$${ℒ}_{e i k} = \frac{1}{\vert {𝒳}_{s} \vert} {\sum }_{x ∈ {𝒳}_{s}} {( {‖ ∇ Ω ( x ) ‖}_{2} - 1 )}^{2} , \qquad ( 6 )$$

where x denotes a sampled 3D point along the rays in the divided space, and dₓ and d_{D} are the distances from ray origin to the sample point and the observed depth point, respectively. The total training loss is then:

$$ℒ = {w}_{c} {ℒ}_{c} + {w}_{e} {ℒ}_{e} + {w}_{s} {ℒ}_{s} + {w}_{eik} {ℒ}_{eik} . \qquad ( 7 )$$

In some embodiments, the learning is optimized per object without priors and can be efficiently performed within seconds, and the object-centric neural field representation can be trained once for each novel object.

Once trained, object model 408 can be used as a drop-in replacement for a conventional graphics pipeline, to perform efficient rendering of the object for subsequent render-and-compare iterations. In addition to a color rendering, a depth rendering can also be performed for a RGBD (red, green, blue, depth) based pose estimation and tracking. To do so, the marching cubes technique can be used to extract, for an object, a textured mesh from the zero level set of the SDF in object model 408, combined with color projection. At inference, given an object pose, an RGBD image can be rendered following the rasterization process. Alternatively, in some embodiments, the depth image can be directly rendered using the geometry function Q online with sphere tracing. However, experience has shown that doing so leads to less efficiency, especially when there is a large number of pose hypotheses to render in parallel.

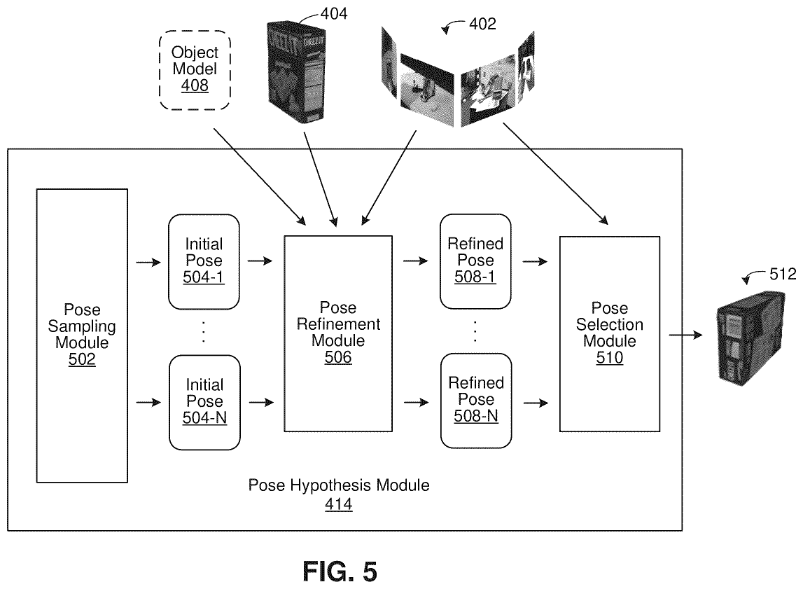

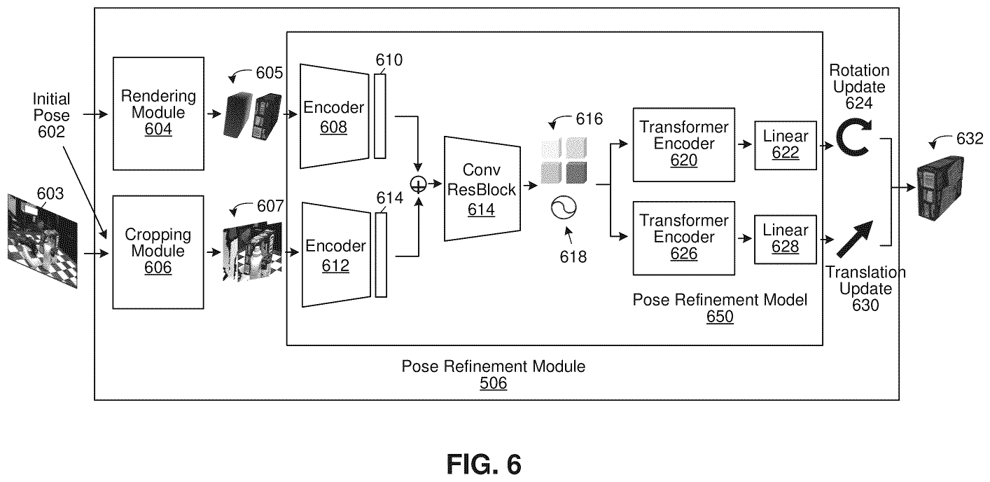

Pose hypothesis module 414 samples a number of initial poses for the object and performs a render-and-compare technique to refine the initial poses to generate pose estimates 416-1 to 416-N (referred to herein collectively as pose estimates 416 and individually as a pose estimate 416), as discussed in greater detail below in conjunction with FIGS. 5-6.

FIG. 5 illustrates in greater detail pose hypothesis module 414 of FIG. 4, according to various embodiments. As shown, pose hypothesis module 414 includes a pose sampling module 502, a pose refinement module 506, and a pose selection module 510. In operation, pose sampling module 502 samples a number of initial poses 504-1 to 504-N (referred to herein collectively as initial poses 504 and individually as an initial pose 504). In some embodiments, pose sampling module 502 can sample the initial poses 504 in any technically feasible manner, such as by discretely sampling a number of rotations on an icosphere (which is used to approximate a sphere for computational efficiency), randomly, etc. For example, in some embodiments, given an RGBD image, pose sampling module 502 can detect an object within the RGBD image in any technically feasible manner, such as using Mask RCNN (Region-based Convolutional Neural Network) or CNOS (CAD-based Novel Object Segmentation). Pose sampling module 502 can then initialize a translation using the 3D point located at the median depth within the detected 3D bounding box. To initialize rotations, pose sampling module 502 can uniformly sample Nₛ viewpoints from an icosphere centered on the object with the camera facing the center. The camera poses can further be augmented with Nᵢ discretized in-plane rotations, resulting in Nₛ·Nᵢ global pose initializations, which can then be sent as input to pose refinement module 506.

Pose refinement module 506 receives as inputs the image(s) 402, either texture CAD model 404 or object model 408 if no texture CAD model is available, and the sampled initial poses 504. Given such inputs, pose refinement module 506 performs a render- and compare technique to compute refined poses 508-1 to 508-N (referred to herein collectively as refined poses 508 and individually as a refined pose 508) for each initial pose 504-1 to 508-N, respectively. Refined poses 508, also referred to herein as intermediate poses, improve the pose quality relative to the initial poses 504. In some embodiments, the render-and-compare technique includes, for each initial pose 504, encoding a rendering of the object in the initial pose 504 as well as a cropping of an input image (e.g., one of input image(s) 402) generated by using the initial pose to project CAD model 404 or object model 408 onto the input image and cropping a bounding window around the projection, processing the feature maps generating by the encodings using a convolutional residual block to generate patches of features with a position embedding, and processing the patches with the position embedding using transformer encoders and linear layers to compute a rotation update and a translation update to the initial pose, as discussed in greater detail below in conjunction with FIG. 6. In some embodiments, the initial poses can be refined in parallel.

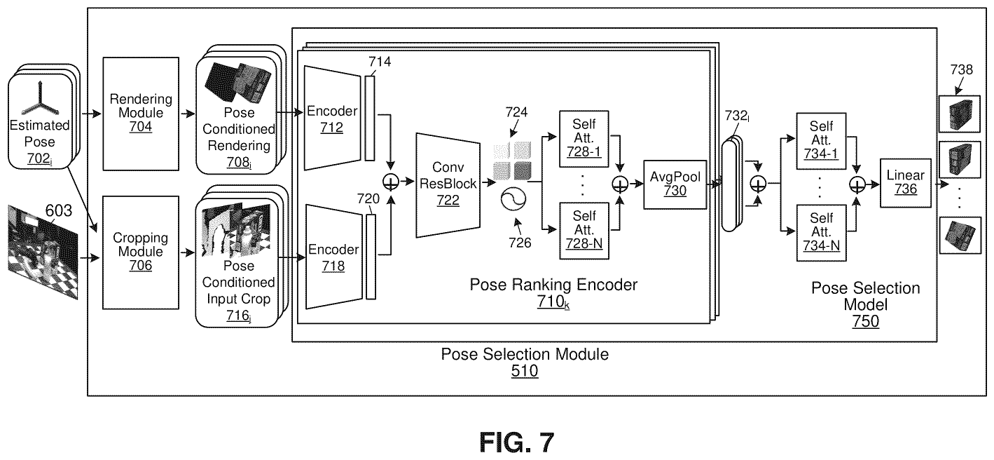

Pose selection module 510 receives the refined poses 508 and the image(s) 402 as inputs, and pose selection module 510 uses a hierarchical multi-head attention technique to select one of the refined poses 508 as output pose 512, as discussed in greater detail below in conjunction with FIG. 7.

FIG. 6 is a more detailed illustration of pose refinement module 506 of pose hypothesis module 414, according to various embodiments. As shown, pose refinement module 506 includes a rendering module 604; a cropping module 606; and a pose refinement model 650 that includes encoders 608 and 612, a convolutional residual block 614, transformer encoders 620 and 626, and linear layers 622 and 628. Given as input an initial pose 602 that is sampled by pose sampling module 502, rendering module 604 renders a RGBD image 605 of the object in initial pose 602. In some embodiments when a textured CAD model of the object is available, rendering module 604 can render the textured CAD model in the initial pose 602 to generate rendered image 605. In some embodiments, when no textured CAD model is available and object model 408 is generated, rendering module 604 can use object model 408 to render image 605. In addition, given as input initial pose 602 and an image 603 that includes the object, cropping module 606 crops image 603 by using initial pose 602 to project CAD model 404 or object model 408 onto image 603 and cropping a bounding window around the projection to generate a pose-conditioned cropped image 607. In some embodiments, pose refinement model is an artificial neural network that takes as input rendered image 605 and cropped image 607 and that outputs an updated pose 632 that is a higher quality pose of the object relative to initial pose 602. Encoders 608 and 612 in pose refinement model 650 encode rendered image 605 and pose-conditioned cropped image 607, respectively, to generate feature maps 610 and 614, which are concatenated and further processed using convolutional residual block 614, whose output is then tokenized (i.e., divided) to generate patches 616 of features with a position embedding 618. Patches 616 with position embedding 618 are then processed (1) using transformer encoder 620 and linear layer 622 to generate a rotation update 624, and (2) using transformer encoder 626 and linear layer 628 to generate a translation update 630. Using transformer encoders 620 and 626, the features of particular patches 616 can attenuate to other patches 616 of the image, providing a global context of the entire image that can enhance the pose refinement and improve robustness. Rotation update 624 and translation update 630 are then applied to initial pose 602 to generate updated pose 632. The foregoing process can also be repeated using the updated pose 632 as the initial pose of a subsequent iteration to iteratively refine the pose quality, thereby performing a recurrent update. In some embodiments, the pose can be refined for a certain number of iterations. In some other embodiments, the pose can be iteratively refined until a change in the pose is below a threshold.

More specifically, in some embodiments, copping module 606 performs a pose conditioned cropping technique so as to provide feedback to the translation update 630. In such cases, copping module 606 can project the object origin to the image space to determine a crop center and then project a slightly enlarged object diameter (the maximum distance between any pair of points on the object surface) to determine the crop size that encloses the object and the nearby context around the pose hypothesis. Such a crop is conditioned on the coarse pose and encourages pose refinement model 650 to update the translation to make the crop better aligned with the observation. As described, the refinement process can also be repeated multiple times by feeding the latest updated pose as input to the next inference, so as to iteratively refine the pose quality.

After cropping module 606 generates pose-conditioned crop image 607 and rendering module 604 renders image 605, both of which can be an RGBD image, encoders 608 and 612, which can be a single shared convolutional neural network (CNN) encoder in some embodiments, extract feature maps from the two RGBD images. Pose refinement module 506 concatenates the feature maps, which are then fed into convolutional residual block 614 that can include CNN blocks with a residual connection, and the output of convolutional residual block 614 is tokenized by dividing into patches 616 of features with position embedding 618. Finally, pose refinement model 500 predicts the translation update 630, Δt ∈ [symbol] ³, and rotation update 624, ΔR ∈ [symbol] (3), each of which is individually processed by transformer encoder 626 and 620, respectively, and linearly projected by linear layers 628 and 622, respectively, to the output dimension. More concretely, Δt represents a translation shift of the object in the camera frame, ΔR represents an orientation update of the object expressed in the camera frame. In practice, the rotations can be parameterized in axis-angle representation. A 6D representation can achieve similar results. The input coarse pose [R|t]∈ [symbol] (3) can then be updated by:

$${t}^{+} = t + Δ t \qquad ( 8 )$$

$${R}^{+} = Δ R ⊗ R , \qquad ( 9 )$$

where ⊗ denotes update on [symbol] (3). Instead of using a single homogeneous pose update, the above disentangled representation removes the dependency on the updated orientation when applying the translation update. Doing so unifies both the updates and input observation in the camera coordinate frame and thus simplifies the learning process. In some embodiments, pose refinement model 650 can be trained using the L₂ loss:

$${ℒ}_{refine} = {w}_{1} ‖ Δ t - Δ \overline{t} \vert {\vert}_{2} + {w}_{2} {‖ Δ R - Δ \overline{R} ‖}_{2} , \qquad ( 10 )$$

where t̅ and R̅ are ground truth; w₁ and w₂ are the weights balancing the losses, which are set to 1 empirically.

FIG. 7 is a more detailed illustration of pose selection module 510 of pose hypothesis module 414, according to various embodiments. As shown, pose selection module 510 includes a rendering module 704, a cropping module 706, and a pose selection model 750 that includes pose rank encoders 710ₖ (referred to herein collectively as pose rank encoders 710 and individually as a pose rank encoder 710), self-attention layers 734-1 to 734-N (referred to herein collectively as self-attention layers 734 and individually as a self-attention layer 734), and a linear layer 736. In some embodiments, pose selection model 750 can be an artificial neural network.

Given as input estimated poses 702ᵢ (referred to herein collectively as estimated poses 702 and individually as an estimated pose 702) that are output by pose sampling module 502, rendering module 704 renders pose-conditioned RGBD (red, green, blue, depth) images 708ᵢ (referred to herein collectively as pose-conditioned rendered images 708 and individually as a pose-conditioned rendered image 708) of the object in the estimated poses 702. In some embodiments when a textured CAD model of the object is available, rendering module 704 can render the textured CAD model in the estimated poses 702 to generate pose-conditioned rendered images 708. In some embodiments when no textured CAD model is available and object model 408 is generated, rendering module 704 can use object model 408 to render pose-conditioned rendered images 708. In addition, given as input estimated poses 702 and image 603 that includes the object, cropping module 706 crops image 603 based on estimated poses 702 in a similar manner as cropping module 606, described above in conjunction with FIG. 6, to generate pose-conditioned cropped input images 716ᵢ (referred to herein collectively as pose-conditioned cropped input images 716 and individually as a pose-conditioned cropped input image 716).

Each pose-conditioned rendered image 708 and corresponding pose-conditioned cropped input image 716, generated using the same pose estimate, is encoded using a respective pose rank encoder 710 in pose selection model 750. As shown, each pose rank encoder 710 includes encoders 712 and 718, a convolutional residual block 722, self-attention layers 728-1 to 728-N (referred to herein collectively as self-attention layers 728 and individually as a self-attention layer 728), and an average pooling layer 730. Encoders 712 and 718 encode a pose-conditioned rendered image 708 and a pose-conditioned cropped input image 716, respectively, to generate feature maps 714 and 720, which are further processed using convolutional residual block 722 to generate patches 724 of features with position embedding 726. Doing so essentially compares the pose-conditioned rendered image 702 with the pose-conditioned cropped image 716. Patches 724 with position embedding 726 are then processed using a multi-head self-attention module that includes self-attention layers 728, as well as average pooling layer 730, to generate feature embeddings 7321 (referred to herein collectively as feature embeddings 732 and individually as a feature embedding 732). Feature embeddings 732 generated by the different pose rank encoders 710 are processed using another multi-head self-attention module that includes self-attention layers 734 that provides a global context of all the estimated poses 702 and compares the feature embedding embeddings 732 among estimated poses 702, as well as linear layer 736, to generate a ranking 738 (e.g., a vector of floating point numbers) of the estimated poses 702. Pose selection module 510 can then select one of the estimated poses 702 having a highest ranking, as indicated by ranking 738.

More specifically, in some embodiments pose selection model 750 can be implemented as a hierarchical pose ranking network that computes scores for estimated poses 702, and pose selection module 510 selects the highest score as the final estimated pose. In some embodiments, pose selection model 750 uses a two-level comparison strategy. First, for each estimated pose 702, a pose-conditioned rendered image 708 is compared against a pose-conditioned input crop 716 for the estimated pose using a pose ranking encoder 710, utilizing the same backbone architecture for feature extraction as in the refinement network of pose refinement model 650. The extracted features 610 and 614 are then concatenated, tokenized, and forwarded to the multi-head self-attention module that includes self-attention layers 728 so as to better leverage the global image context for comparison. Each pose ranking encoder 710 performs average pooling to output a feature embedding 732, [symbol] ∈ [symbol] ⁵¹², describing the alignment quality between the rendering and the cropped input.

It should be noted that directly projecting the feature embedding F to a similarity scalar would ignore the other pose hypotheses, forcing pose selection model 720 to output an absolute score assignment which can be difficult to learn. In some embodiments, pose selection model 750 instead leverages the global context of all estimated poses 702 in order to make a more informed decision, using a second level of comparison among all the K estimated poses 702. In such cases, multi-head self-attention is performed on the concatenated feature embedding F=[ [symbol] ₀, . . . , [symbol] _{K-1}]^{T} ∈ [symbol] ^{K×512}, which encodes the pose alignment information from all estimated poses 702. By treating F as a sequence, such an approach naturally generalizes to varying lengths of K. Position encoding is not applied to F, so as to be agnostic to the permutation. The attended feature is then linearly projected using linear layer 736 to scores S∈ [symbol] ^{K} that are assigned to the estimated poses 702.

In some embodiments, pose selection model 750 can be trained using a pose-conditioned triplet loss:

$$ℒ ( {i}^{+} , {i}^{-} ) = max ( S ( {i}^{-} ) - S ( {i}^{+} ) + α , 0 ) , \qquad ( 11 )$$

where α denotes the contrastive margin; i⁻ and i⁺ represent the negative and positive pose samples, respectively, which are determined by computing the average distance (ADD) metric using ground truth data. It should be noted that, different from the standard triplet loss, the anchor sample is not shared between the positive and negative samples, since the input is cropped depending on each estimated pose to account for translations. While the loss of equation (11) can be computed over each pair in the list, the comparison becomes ambiguous when both poses are far from ground truth. Therefore, in some embodiments, training of pose selection model 750 only uses pose pairs whose positive sample is from a viewpoint that is close enough to the ground truth to make the comparison meaningful:

$${𝕍}^{+} = \{ i : D ( {R}_{i} , \overline{R} ) < d \} , \qquad ( 12 )$$

$${𝕍}^{-} = \{ 0 , 1 , 2 , … , K - 1 \} , \qquad ( 13 )$$

$${ℒ}_{rank} = {\sum }_{{i}^{+} , {i}^{-}} ℒ ( {i}^{+} , {i}^{-} ) , \qquad ( 14 )$$

where the summation is over i⁺∈ [symbol] ⁺, i⁻∈ [symbol] ⁻, i⁺≠i⁻; Rᵢ and R̅ are the rotation of the hypothesis and ground truth, respectively; D(·) denotes the geodesic distance between rotations; and d is a predefined threshold. Using only pose pairs whose positive sample is from a viewpoint that is close enough to the ground truth, which is also referred to herein as “contrast validation,” helps to stabilize the training of pose selection model 750.

Although FIGS. 5-7 are described with respect to estimating the pose of an object within a single image for simplicity, in some embodiments, pose estimation application 130 can also estimate the poses of an object across different images, such as multiple frames of a video, which is also sometimes referred to as “pose tracking.” In such cases, pose estimation application 130 can use the object pose that is estimated for a first image (e.g., a first frame of a video) according to the techniques described above in conjunction with FIGS. 5-7 as the initial pose estimate for a subsequent image (e.g., a second frame of the video), and then repeat the pose estimation technique to generate a pose estimate for the subsequent image, etc., until all of the images have been processed.

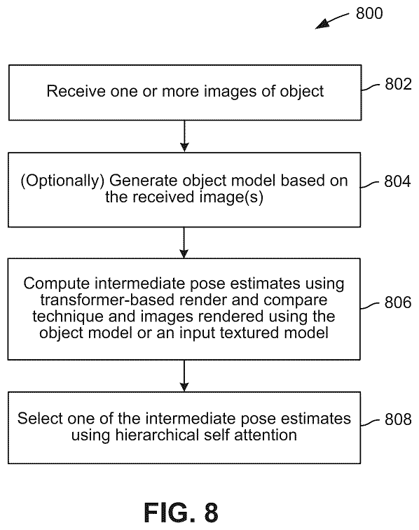

FIG. 8 is a flow diagram of method steps for estimating the pose of an object, according to various embodiments. Although the method steps are described in conjunction with FIGS. 1-7, persons skilled in the art will understand that any system configured to perform the method steps, in any order, falls within the scope of the present disclosure.

As shown, a method 800 begins at step 802, where pose estimation application 130 receives one or more images of an object. For example, the received image(s) could be standalone images captured from different viewpoints or multiple frames of a video.

At step 804, pose estimation application 130 optionally generates an object model based on the received image(s). In some embodiments, the object model can be an object-centric neural field representation that includes a geometry model and an appearance model and that is trained using the image(s) received at step 802, as described above in conjunction with FIG. 4.

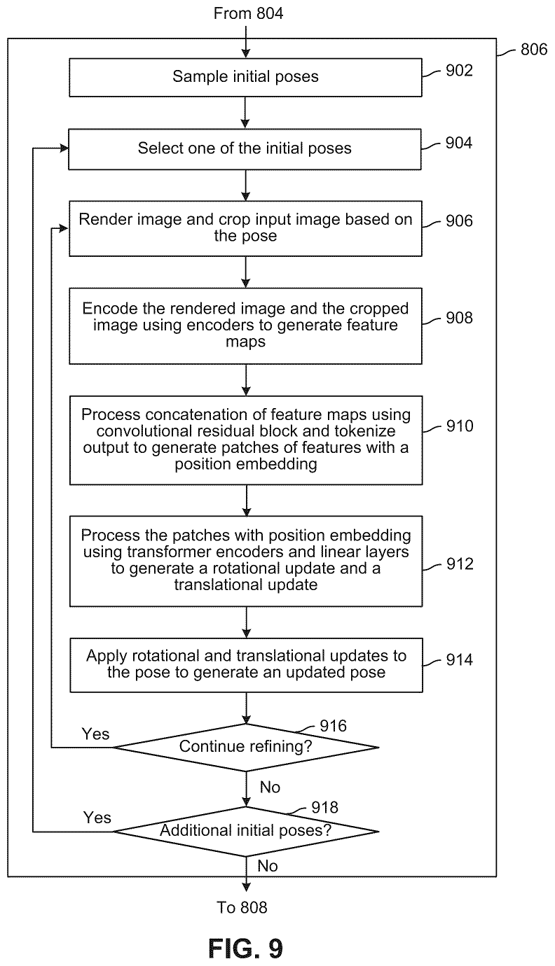

At step 806, pose estimation application 130 computes intermediate pose estimates using a transformer-based render and compare technique and images rendered using the object model or an input textured model. In some embodiments, pose estimation application 130 can compute the intermediate pose estimates by sampling a number of initial poses and, for each initial pose, rendering an image and cropping an input image from the received image(s) based on the pose, encoding the rendered image and the cropped image to generate feature maps, dividing the feature maps into patches of features with a position embedding using a convolutional residual block, processing the patches with the position embedding using transformer encoders and linear layers to generate a rotation update and a translation update, applying the rotation update and the translation update to the pose to generate an updated pose, and repeating the foregoing steps any number of times to obtain the intermediate pose estimates, as discussed in greater detail below in conjunction with FIG. 9.

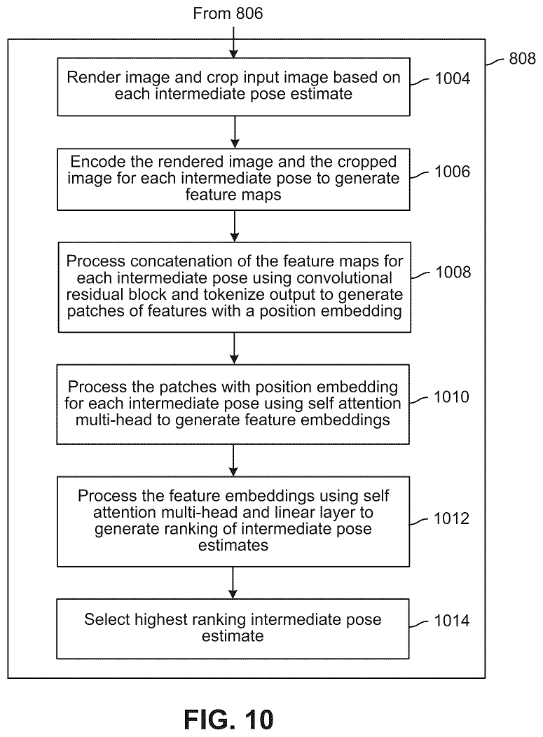

At step 808, pose estimation application 130 selects one of the intermediate pose estimates using a hierarchical self-attention technique. In some embodiments, pose estimation application 130 can render an image and crop an input image based on each intermediate pose estimate, encode the rendered image and the cropped image for each intermediate pose using encoders to generate feature maps, divide the feature maps for each intermediate pose into patches of features with a position embedding using a convolutional residual block, process the patches with the position embedding for each intermediate pose using a self-attention multi-head to generate feature embeddings, process the patches with the position embedding for each intermediate pose using a self-attention multi-head to generate feature embeddings for the intermediate poses, process the feature embeddings using another self-attention multi-head and a linear layer to generate a ranking of intermediate pose estimates, and select a highest ranking intermediate pose estimate, as discussed in greater detail below in conjunction with FIG. 10.

FIG. 9 is a flow diagram of method steps for computing intermediate pose estimates at step 806 of method 800, according to various embodiments. Although the method steps are described in conjunction with FIGS. 1-7, persons skilled in the art will understand that any system configured to perform the method steps, in any order, falls within the scope of the present disclosure.

As shown, at step 902, pose estimation application 130 samples a number of initial poses. In some embodiments, pose estimation application 130 can sample initial poses that include different rotations that are discretely sampled on an icosphere, randomly, or in any other technically feasible manner.

At step 904, pose estimation application 130 selects one of the initial poses. Although described with respect to selecting and refining the initial poses sequentially for simplicity, in some embodiments, the initial poses can be refined in parallel.

At step 906, pose estimation application 130 renders an image and crops an input image based on the pose. In some embodiments, pose estimation application 130 can perform the pose conditioned cropping technique described above in conjunction with FIG. 6 to crop the input image.

At step 908, pose estimation application 130 encodes the rendered image and the cropped image using encoders (e.g., encoders 608 and 610) to generate feature maps.

At step 910, pose estimation application 130 processes a concatenation of the feature maps using a convolutional residual block (e.g., convolution residual block 614) and tokenizes an output of the convolutional residual block to generate patches of features with a position embedding, as described above in conjunction with FIG. 6.

At step 912, pose estimation application 130 processes the patches with the position embedding using transformer encoders and linear layers to generate a rotation update and a translation update for the pose. In some embodiments, patches with a position embedding are processed using a transformer encoder and a linear layer (e.g., transformer encoder 620 and linear layer 622) to generate a rotation update, and using another transformer encoder and linear layer (e.g., transformer encoder 626 and linear layer 628) to generate a translation update, as described above in conjunction with FIG. 6.

At step 914, pose estimation application 130 applies the rotation update and the translation update to the pose to generate an updated pose.

At step 916, if pose estimation application 130 determines to continue refining the pose, then method 800 returns to step 906, where pose estimation application 130 renders an image and crops the input image based on the updated pose. In some embodiments, pose estimation application 130 can refine the pose for a certain number of iterations. In some other embodiments, pose estimation application 130 can continue iteratively refining the pose until a change in pose is below a threshold.

On the other hand, if pose estimation application 130 determines at step 916 to stop refining the pose, then the currently refined pose is saved as one of the intermediate pose(s), and method 800 continues to step 918. At step 918, if there are additional initial poses, method 800 returns to step 904, where pose estimation application 130 selects another one of the initial poses to process. On the other hand, if there are no additional initial poses, then method 800 continues to step 808, where pose estimation application 130 selects one of the intermediate pose estimates using hierarchical self-attention.

FIG. 10 is a flow diagram of method steps for selecting one of the intermediate pose estimates at step 808 of method 800, according to various embodiments. Although the method steps are described in conjunction with FIGS. 1-7, persons skilled in the art will understand that any system configured to perform the method steps, in any order, falls within the scope of the present disclosure.

As shown, at step 1002, pose estimation application 130 renders an image and crops an input image based on each intermediate pose estimate determined at step 906. In some embodiments, pose estimation application 130 can perform the pose conditioned cropping technique described above in conjunction with FIG. 7 to crop the input image.

At step 1006, pose estimation application 130 encodes the rendered image and the cropped image for each intermediate pose using encoders (e.g., encoders 712 and 718) to generate feature maps. In some embodiments, pose estimation application 130 includes encoders that encodes the rendered image and the cropped image, respectively, to generate feature maps, which are further processed using convolutional residual block to generate patches with a position embedding, as described above in conjunction with FIG. 7.

At step 1008, pose estimation application 130 processes a concatenation of the feature maps for each intermediate pose using a convolutional residual block (e.g., convolutional residual block 722) and tokenizes an output of the convolutional residual block to generate patches of features with a position embedding for the intermediate pose. Step 1008 is similar to step 910, described above in conjunction with FIG. 9.

At step 1010, processes the patches with the position embedding for each intermediate pose using a self-attention multi-head to generate feature embeddings for the intermediate poses. In some embodiments, patches with a position embedding are processed using a multi-head self-attention module that includes self-attention layers (e.g., self-attention layers 728), as well as an average pooling layer (e.g., average pooling layer 730), to generate feature embeddings, as described above in conjunction with FIG. 7.

At step 1012, pose estimation application 130 processes the feature embeddings using another self-attention multi-head and a linear layer to generate a ranking of intermediate pose estimates. In some embodiments, feature embeddings generated at step 1010 are processed using another multi-head self-attention module that includes self-attention layers (e.g., self-attention layers 734), as well as a linear layer (e.g., linear layer 736) that linearly projects high-dimensional outputs of the other self-attention module to a vector of scalar floating point numbers indicating a ranking of the intermediate poses. The other multi-head self-attention module permits the feature embeddings to attend to each other to provide a global context of different pose hypotheses, thereby permitting information from other intermediate poses to be used to judge where each intermediate pose ranks among the intermediate poses.

At step 1014, pose estimation application 130 selects a highest ranking intermediate pose estimate from the ranking of intermediate poses generated at step 1012.

In sum, techniques are disclosed for 6-DoF object pose estimation. In some embodiments, a pose estimation application receives one or more images of an object, such as images captured from different viewpoints and/or the frames of a video. The pose estimation application optionally generates an object model for rendering images of the object. The object model can be an object-centric neural field representation that includes a geometry model that can be queried to render geometry of the object and an appearance model that can be queried to render colors of the object. Using the object model or a received CAD model of the object, the pose estimation application computes intermediate pose estimates for the object within an image via a render and compare technique. The render and compare technique uses transformer encoders, among other things, to compute position and rotation updates that can be applied to an initial sampled pose estimate to obtain a refined pose. In addition, multiple initial pose estimates can be sampled, and the pose estimation application can select one of the refined poses computed for the multiple initial pose estimates using a hierarchical self-attention technique that ranks the refined poses.

One technical advantage of the disclosed techniques relative to the prior art is that, with the disclosed techniques, a trained machine learning model can be used to predict the poses of different objects, including other objects and objects of different types that were not included in images used to train the machine learning model. In addition, with the disclosed techniques, the trained machine learning model can be applied to predict the poses of objects in standalone images as well as in multiple frames of a video. The disclosed techniques also can be used to predict the poses of objects for which a computer-aided design (CAD) model is available as well as the poses of objects for which no CAD model is available. These technical advantages provide one or more technological improvements over prior art approaches.
1. In some embodiments, a computer-implemented method for determining object poses comprises receiving a first image of an object, sampling an initial pose of the object, and performing one or more operations to update the initial pose to determine a first pose of the object based on the first image, a first rendered image of the object in the initial pose, and one or more transformer encoders.
2. The computer-implemented method of clause 1, further comprising sampling one or more additional initial poses of the object, performing one or more operations to update the one or more additional initial poses to generate one or more additional poses of the object, and selecting a second pose of the object from the first pose and the one or more additional poses.
3. The computer-implemented method of clauses 1 or 2, wherein selecting the second pose comprises generating a ranking for each of the first pose and the one or more additional poses using a hierarchy of self-attention layers, and selecting one of the first pose or the one or more additional poses that is associated with a highest ranking as the second pose.
4. The computer-implemented method of any of clauses 1-3, wherein generating the ranking comprises processing, via the hierarchy of self-attention layers, one or more second images that are cropped from the first image based on the first pose and the one or more additional poses, and one or more third images of the object that are rendered based on the first pose and the one or more additional poses
5. The computer-implemented method of any of clauses 1-4, wherein the initial pose and the one or more additional initial poses include one or more rotations that are sampled on an icosphere.
6. The computer-implemented method of any of clauses 1-5, wherein performing the one or more operations to update the initial pose comprises rendering the object based on the initial pose to generate the first rendered image, cropping the first image based on the initial pose to generate a cropped image, and processing the first rendered image and the cropped image using a trained machine learning model that comprises the one or more transformer encoders.
7. The computer-implemented method of any of clauses 1-6, further comprising performing one or more operations to generate a model of the object, and rendering the first rendered image based on the model of the object.
8. The computer-implemented method of any of clauses 1-7, wherein the first rendered image is rendered based on a computer-aided design (CAD) model of the object.
9. The computer-implemented method of any of clauses 1-8, further comprising receiving a second image of the object, wherein the first image and the second image are consecutive frames of a video, and updating the first pose to determine a second pose of the object within the second image based on the second image, a second rendered image of the object in the first pose, and the one or more transformer encoders.
10. The computer-implemented method of any of clauses 1-9, further comprising at least one of rendering an image, controlling a vehicle, or controlling a robot based on the first pose of the object.
11. In some embodiments, one or more non-transitory computer-readable media store program instructions that, when executed by at least one processor, cause the at least one processor to perform the steps of receiving a first image of an object, sampling an initial pose of the object, and performing one or more operations to update the initial pose to determine a first pose of the object based on the first image, a first rendered image of the object in the initial pose, and one or more transformer encoders.
12. The one or more non-transitory computer-readable media of clause 11, wherein the instructions, when executed by the at least one processor, further cause the at least one processor to perform the steps of sampling one or more additional initial poses of the object, performing one or more operations to update the one or more additional initial poses to generate one or more additional poses of the object, and selecting a second pose of the object from the first pose and the one or more additional poses.
13. The one or more non-transitory computer-readable media of clauses 11 or 12, wherein selecting the second pose comprises generating a ranking for each of the first pose and the one or more additional poses using a hierarchy of self-attention layers, and selecting one of the first pose or the one or more additional poses that is associated with a highest ranking as the second pose.
14. The one or more non-transitory computer-readable media of any of clauses 11-13, wherein the instructions, when executed by the at least one processor, further cause the at least one processor to perform the step of performing one or more operations to train a machine learning model that comprises the hierarchy of self-attention layers based on a pose-conditioned triplet loss and a plurality of pairs of pose samples, each pair of pose samples in the plurality of pairs of pose samples including a positive pose sample from a viewpoint that is less than a threshold from a corresponding ground truth pose.
15. The one or more non-transitory computer-readable media of any of clauses 11-14, wherein performing the one or more operations to update the initial pose comprises rendering the object based on the initial pose to generate the first rendered image, cropping the first image based on the initial pose to generate a cropped image, and processing the first rendered image and the cropped image using a trained machine learning model that comprises the one or more transformer encoders.
16. The one or more non-transitory computer-readable media of any of clauses 11-15, wherein the one or more transformer encoders includes a first transformer encoder used to generate a position update to the initial pose and a second transformer encoder used to generate a rotation update to the initial pose.
17. The one or more non-transitory computer-readable media of any of clauses 11-16, wherein the instructions, when executed by the at least one processor, further cause the at least one processor to perform the step of performing one or more operations to train a machine learning model that includes the one or more transformer encoders.
18. The one or more non-transitory computer-readable media of any of clauses 11-17, wherein the instructions, when executed by the at least one processor, further cause the at least one processor to perform the steps of performing one or more operations to generate a model of the object, and rendering the first rendered image based on the model of the object.
19. The one or more non-transitory computer-readable media of any of clauses 11-18, wherein the instructions, when executed by the at least one processor, further cause the at least one processor to perform the steps of receiving a second image of the object, wherein the first image and the second image are consecutive frames of a video, and updating the first pose to determine a second pose of the object within the second image based on the second image, a second rendered image of the object in the first pose, and the one or more transformer encoders.
20. In some embodiments, a system comprises one or more memories storing instructions, and one or more processors that are coupled to the one or more memories and, when executing the instructions, are configured to receive a first image of an object, sample an initial pose of the object, and perform one or more operations to update the initial pose to determine a first pose of the object based on the first image, a first rendered image of the object in the initial pose, and one or more transformer encoders.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for determining object poses, the method comprising:
receiving a first image of an object;
sampling an initial pose of the object; and
performing one or more operations to update the initial pose to determine a first pose of the object based on the first image, a first rendered image of the object in the initial pose, and one or more transformer encoders.

2. The computer-implemented method of claim 1, further comprising:
sampling one or more additional initial poses of the object;
performing one or more operations to update the one or more additional initial poses to generate one or more additional poses of the object; and
selecting a second pose of the object from the first pose and the one or more additional poses.

3. The computer-implemented method of claim 2, wherein selecting the second pose comprises:
generating a ranking for each of the first pose and the one or more additional poses using a hierarchy of self-attention layers; and
selecting one of the first pose or the one or more additional poses that is associated with a highest ranking as the second pose.

4. The computer-implemented method of claim 3, wherein generating the ranking comprises processing, via the hierarchy of self-attention layers, one or more second images that are cropped from the first image based on the first pose and the one or more additional poses, and one or more third images of the object that are rendered based on the first pose and the one or more additional poses.

5. The computer-implemented method of claim 2, wherein the initial pose and the one or more additional initial poses include one or more rotations that are sampled on an icosphere.

6. The computer-implemented method of claim 1, wherein performing the one or more operations to update the initial pose comprises:
rendering the object based on the initial pose to generate the first rendered image;
cropping the first image based on the initial pose to generate a cropped image; and
processing the first rendered image and the cropped image using a trained machine learning model that comprises the one or more transformer encoders.

7. The computer-implemented method of claim 1, further comprising:
performing one or more operations to generate a model of the object; and
rendering the first rendered image based on the model of the object.

8. The computer-implemented method of claim 1, wherein the first rendered image is rendered based on a computer-aided design (CAD) model of the object.

9. The computer-implemented method of claim 1, further comprising:
receiving a second image of the object, wherein the first image and the second image are consecutive frames of a video; and
updating the first pose to determine a second pose of the object within the second image based on the second image, a second rendered image of the object in the first pose, and the one or more transformer encoders.

10. The computer-implemented method of claim 1, further comprising at least one of rendering an image, controlling a vehicle, or controlling a robot based on the first pose of the object.

11. One or more non-transitory computer-readable media storing program instructions that, when executed by at least one processor, cause the at least one processor to perform the steps of:
receiving a first image of an object;
sampling an initial pose of the object; and
performing one or more operations to update the initial pose to determine a first pose of the object based on the first image, a first rendered image of the object in the initial pose, and one or more transformer encoders.

12. The one or more non-transitory computer-readable media of claim 11, wherein the instructions, when executed by the at least one processor, further cause the at least one processor to perform the steps of:
sampling one or more additional initial poses of the object;
performing one or more operations to update the one or more additional initial poses to generate one or more additional poses of the object; and
selecting a second pose of the object from the first pose and the one or more additional poses.

13. The one or more non-transitory computer-readable media of claim 12, wherein selecting the second pose comprises:
generating a ranking for each of the first pose and the one or more additional poses using a hierarchy of self-attention layers; and
selecting one of the first pose or the one or more additional poses that is associated with a highest ranking as the second pose.

14. The one or more non-transitory computer-readable media of claim 13, wherein the instructions, when executed by the at least one processor, further cause the at least one processor to perform the step of performing one or more operations to train a machine learning model that comprises the hierarchy of self-attention layers based on a pose-conditioned triplet loss and a plurality of pairs of pose samples, each pair of pose samples in the plurality of pairs of pose samples including a positive pose sample from a viewpoint that is less than a threshold from a corresponding ground truth pose.

15. The one or more non-transitory computer-readable media of claim 11, wherein performing the one or more operations to update the initial pose comprises:
rendering the object based on the initial pose to generate the first rendered image;
cropping the first image based on the initial pose to generate a cropped image; and
processing the first rendered image and the cropped image using a trained machine learning model that comprises the one or more transformer encoders.

16. The one or more non-transitory computer-readable media of claim 11, wherein the one or more transformer encoders includes a first transformer encoder used to generate a position update to the initial pose and a second transformer encoder used to generate a rotation update to the initial pose.

17. The one or more non-transitory computer-readable media of claim 15, wherein the instructions, when executed by the at least one processor, further cause the at least one processor to perform the step of performing one or more operations to train a machine learning model that includes the one or more transformer encoders.

18. The one or more non-transitory computer-readable media of claim 11, wherein the instructions, when executed by the at least one processor, further cause the at least one processor to perform the steps of:
performing one or more operations to generate a model of the object; and
rendering the first rendered image based on the model of the object.

19. The one or more non-transitory computer-readable media of claim 11, wherein the instructions, when executed by the at least one processor, further cause the at least one processor to perform the steps of:
receiving a second image of the object, wherein the first image and the second image are consecutive frames of a video; and
updating the first pose to determine a second pose of the object within the second image based on the second image, a second rendered image of the object in the first pose, and the one or more transformer encoders.

20. A system, comprising:
one or more memories storing instructions; and
one or more processors that are coupled to the one or more memories and, when executing the instructions, are configured to:
receive a first image of an object,
sample an initial pose of the object, and
perform one or more operations to update the initial pose to determine a first pose of the object based on the first image, a first rendered image of the object in the initial pose, and one or more transformer encoders.
